(19) United States
(12) Patent Application Publication
(10) Pub. No.: US 2008/0206617 A1
(43) Pub. Date: Aug. 28, 2008

(54) Fuel Cell Separators

(75) Inventors: Keiji Okada, Yokohama-shi (JP); Atsushi Miyazawa, Yokohama-shi (JP)

Correspondence Address: YOUNG & BASILE, P.C., 3001 WEST BIG BEAVER ROAD, SUITE 624, TROY, MI, 48084, US

(73) Assignee: Nissan Motor Co., Ltd., Yokohama-shi, Kanagawa (JP)

(21) Appl. No.: 11/815,067

(22) PCT Filed: Apr. 10, 2006
(86) PCT No.: PCT/IB06/00831

§ 371 Date: Jul. 30, 2007

(30) Foreign Application Priority Data
Apr. 12, 2005 (JP) 2005-114332

(51) Int. Cl. H01M 8/10

(52) U.S. Cl. 429/30; 429/34; 29/730

(57) ABSTRACT

The disclosure relates to fuel cell systems including a multiplicity of unit fuel cells arranged in a stack, with each unit fuel cell separated by an electrode separator assembly. Each unit fuel cell includes a membrane electrode assembly with an anode, a cathode, and a solid polymer electrolyte membrane disposed between the anode and the cathode. An anode separator is positioned between each membrane electrode assembly of adjoining unit fuel cells within the stack in contact with an anode, and a cathode separator is positioned between each membrane electrode assembly of adjoining unit fuel cells within the stack in contact with a cathode. A surface of an anode separator is joined to a surface of a cathode separator of an adjoining unit fuel cell to form an electrode separator assembly. The disclosure also relates to a method of making a fuel cell assembly.

This application claims priority to Japanese Patent Application No. 2005-114332, filed Apr. 12, 2005, the entire content of which is incorporated herein by reference.

### TECHNICAL FIELD

The invention relates to fuel cells and fuel cell systems.

### BACKGROUND

In a fuel cell, a fuel gas such as hydrogen and an oxidant gas containing oxygen are electrochemically reacted across an electrolyte to produce electrical energy. Conventional fuel cell systems contain one or more unit fuel cells including a fuel electrode (anode), an oxidizing electrode (cathode), and an electrolyte membrane separating the electrodes and having a gas passage formed to supply oxidant gas (e.g. air) to the oxidizing electrode and fuel gas (e.g. hydrogen) to the fuel electrode (e.g. anode).

Many unit fuel cells may be combined in a stack to form a fuel cell system. The unit fuel cells are electrically connected to each other and may be connected to a load to produce an electrical current. In a fuel cell system, it is necessary to provide fuel gas, oxidant gas, and sometimes a cooling medium through their respective pathways to the respective anode or cathode surface of the membrane electrode assembly in an air-tight or liquid-tight manner. Fuel cell systems may thus include fluid connections for supplying or exhausting oxidant gas, fuel gas, and cooling fluids to and from the unit fuel cells within the fuel cell stack; and electrical connections providing electrical continuity between adjoining unit fuel cells.

Ensuring that the electrical and fluid connections between adjoining fuel cells in a fuel cell stack maintain fluid and electrical continuity without fluid leakage or electrical current disruption presents many practical difficulties for which the art constantly seeks new solutions. Misalignment or degradation of fluid and electrical seals is a particular concern for fuel cells used in vehicles, because vehicle vibration and forces applied during sudden acceleration/deceleration may cause misalignment and leakage of the seals, or short circuits.

### SUMMARY

The invention is directed generally to fuel cells and fuel cell systems including electrode separator assemblies.

In one embodiment, the invention relates to a fuel cell system including a multiplicity of unit fuel cells arranged in a fuel cell stack with each unit fuel cell separated by an electrode separator assembly. Each unit fuel cell includes a membrane electrode assembly with an anode, a cathode, and a solid polymer electrolyte membrane disposed between the anode and the cathode. An anode separator is positioned between each membrane electrode assembly of adjoining unit fuel cells within the stack in contact with an anode, and a cathode separator is positioned between each membrane electrode assembly of adjoining unit fuel cells within the stack in contact with a cathode. A surface of an anode separator is joined to a surface of a cathode separator of an adjoining unit cell to form an electrode separator assembly.

In certain exemplary embodiments, the fuel cell stack may be held together by plurality of connecting members, each connecting member extending through the electrode separator assemblies and their adjoining membrane electrode assemblies without penetrating an activating surface of the anodes, cathodes, or membranes. In other exemplary embodiments, the electrode separator assemblies are joined to a cathode or anode surface to form a fluid conduit for delivering a fuel cell working fluid to the unit fuel cells within the fuel cell stack.

In further exemplary embodiments, an anode separator may be joined to the adjoining cathode separator by a plurality of joints formed between one or more of the contact surfaces between the anode separator and the adjoining cathode separator. In additional exemplary embodiments, the anode separators and cathode separators comprise a metal, and each anode separator may be joined to each cathode separator of the adjoining unit fuel cell by one or more welds.

In another embodiment, the invention relates to a fuel cell assembly including multiplicity of unit fuel cells arranged in a fuel cell stack. Each unit fuel cell includes membrane electrode assembly with an anode, a cathode, and an electrolyte membrane disposed between the anode and the cathode. The fuel cell assembly includes means joining each cathode to each adjoining anode, thereby electrically connecting each cathode to each anode and providing a delivery path for at least one fuel cell working fluid to each cathode and each anode. The means for joining each cathode to each adjoining anode may include welds, soldered joints, adhesive bonds, and all substantial equivalents that perform the function of joining each cathode to each adjoining anode to electrically connect each cathode to each anode and provide a delivery path for at least one fuel cell working fluid to each cathode and each anode.

In exemplary embodiments, the electrode separator assembly includes an anode separator of a unit fuel cell joined to a cathode separator of an adjoining unit fuel cell to form a fluid conduit between the anode separator and the cathode separator of each adjoining unit fuel cell in the fuel cell stack. In certain embodiments, the means for joining each cathode to each anode includes one or more welds formed between a cathode and the adjacent cathode separator, and one or more welds formed between an anode and the adjacent anode separator. In additional embodiments, a surface of each anode separator may be joined to a surface of the adjoining cathode separator to form an electrode separator assembly. In some exemplary embodiments, one or more welds may be formed between the anode separator and the adjoining cathode separator.

In a further embodiment, the invention relates to a method of making a fuel cell assembly. The method includes forming a fuel cell stack by stacking a multiplicity of unit fuel cells. Each unit fuel cell comprises a membrane electrode assembly including an anode in contact with an anode separator, a cathode in contact with a cathode separator, and a solid polymer electrolyte membrane disposed between the anode and the cathode. The method includes joining each anode separator to each adjoining cathode separator of the adjoining unit fuel cell. In certain embodiments, joining may be achieved by welding a contact surface of each anode separator to a contact surface of the adjoining cathode separator. In certain exemplary embodiments, welding is selected from laser beam or electron beam welding.

In certain aspects of the present invention, the deformation or bowing of the membrane electrode assemblies of the individual unit fuel cells in a fuel cell stack may be reduced or prevented. In other aspects, the surface pressure between adjoining surfaces of unit fuel cells in a fuel cell stack may be reduced or made more uniform, and the size and weight of end plates used to hold together the unit fuel cells in a fuel cell stack may also be reduced. In further aspects, the contact resistance between unit fuel cells may be reduced using exemplary electrode separator assemblies according to embodiments of the present invention, permitting the fuel cell stack to be made smaller and lighter and decreasing the cost of the stack.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a side perspective view illustrating a fuel cell assembly including a fuel cell stack in which unit fuel cells are separated by an electrode separator assembly according to a first embodiment of the present invention.

FIG. 2 is an enlarged cross-sectional side view of a unit fuel cell including a membrane electrode assembly using an electrode separator assembly according to the first embodiment of the present invention.

FIG. 3 is a side perspective view illustrating the contact surface of the cathode separator with the cathode surface of the membrane electrode assembly of a unit fuel cell according to the first embodiment of the present invention.

FIG. 4 is a side perspective view illustrating the active surface and contact surface of the cathode separator with membrane electrode assembly showing the contact area joining the cathode separator and anode separator to form an electrode separator assembly according to the first embodiment of the present invention.

FIG. 5 is an enlarged cross-sectional side view of a portion of the electrode separator assembly illustrating a joint formed between a contact surface of the anode separator and the adjoining cathode separator to form an electrode separator assembly according to the first embodiment of the present invention.

FIG. 6A is a side perspective view illustrating bowing of end plates and collecting plates of an un-welded fuel cell assembly according to the Prior Art.

FIG. 6B is a graph illustrating the relationship between the surface pressure and bowing of the end plates and collecting plates of an un-welded fuel cell assembly according to the Prior Art and a welded fuel cell assembly according to another embodiment of the present invention.

FIG. 7 is a graph illustrating the relationship between the surface pressure and the contact resistance of an un-welded fuel cell assembly according to the Prior Art and a welded fuel cell assembly according to another embodiment of the present invention.

FIG. 8 is a side perspective view illustrating the joints (e.g. welds) formed between the contact surfaces of the cathode separator and the cathode of the membrane electrode assembly of a unit fuel cell in a fuel cell stack according to a second embodiment of an electrode separator assembly of the present invention.

FIG. 9A is a side perspective view illustrating the position of the joints (e.g. welds) to be formed on the contact surface of the anode separator with the anode of the membrane electrode assembly of a unit fuel cell in a fuel cell stack according to another embodiment of an electrode separator assembly of the present invention.

FIG. 9B is an edge cross-sectional view illustrating the electrode separator assembly formed by joining one or more of the contact surfaces between the anode separator and the adjoining cathode separator according to the embodiment of an electrode separator assembly of the present invention.

FIG. 10A is a side perspective view illustrating the position of the joints (e.g. welds) to be formed on the contact surface of the cathode separator with the cathode of the membrane electrode assembly of a unit fuel cell in a fuel cell stack corresponding to the embodiment of an electrode separator assembly illustrated in FIGS. 9A and 9B.

FIG. 10B is an edge cross-sectional view illustrating the electrode separator assembly formed by joining one or more of the contact surfaces between the anode separator and the adjoining cathode separator according to the embodiment of an electrode separator assembly illustrated in FIGS. 9A and 9B.

### DETAILED DESCRIPTION

Various embodiments of the present invention will be described with respect to the following Figures and Examples. Other embodiments are within the scope of the claims, and it is understood that the invention is not limited to the specific embodiments described in the following detailed description of the invention, but includes these embodiments, as well as all embodiments encompassed by the claimed elements and their equivalents.

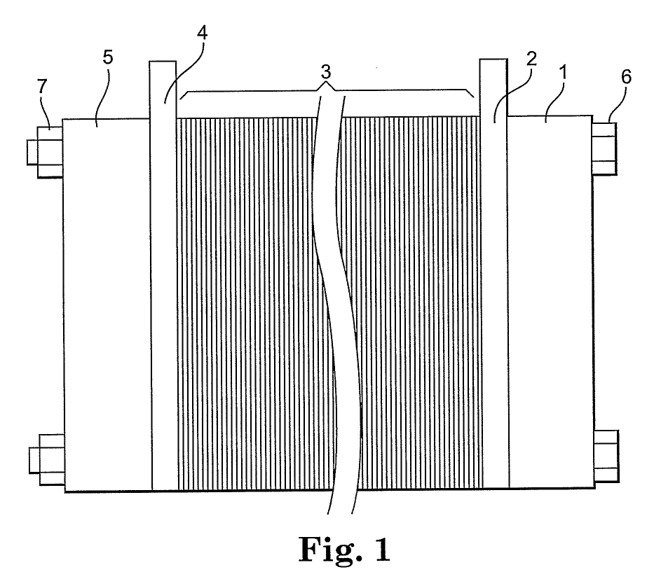

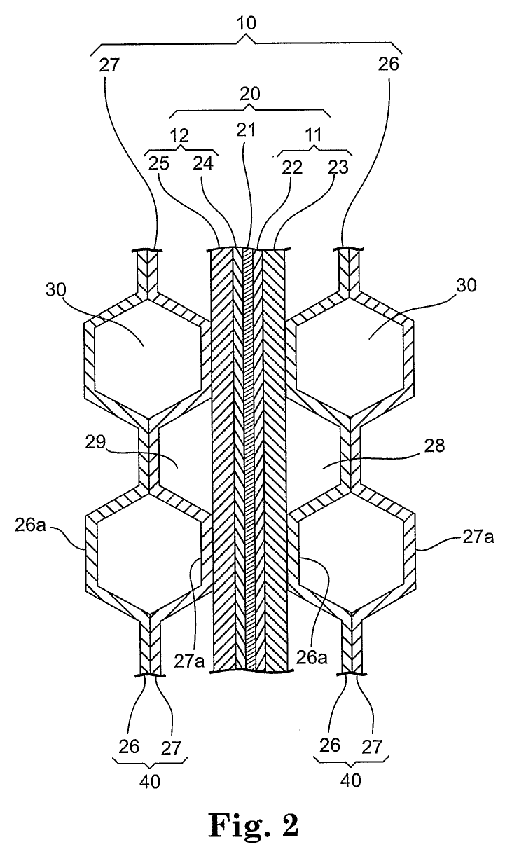

FIG. 1 is a side perspective view illustrating a fuel cell assembly including a fuel cell stack in which unit fuel cells are separated by an electrode separator assembly according to an embodiment of the present invention. The fuel cell assembly shown in FIG. 1 includes end plates 1 and 5, collecting plates 2 and 4 and fuel cell stack 3. As shown in FIG. 2, fuel cell stack 3 may be formed by stacking individual unit fuel cells 10 so that each unit fuel cell 10 is positioned adjacent to at least one adjoining unit fuel cell 10.

In FIG. 1, the fuel cell assembly may include first end plate 1 and second end plate 5 on each end of the fuel cell stack 3, wherein each end is defined relative to the direction of the stacked layers. End plates 1 and 5 are configured to uniformly apply a surface pressure on the unit fuel cells 10 (FIG. 2) within fuel cell stack 3. Collecting plates 2 and 4 are used to collect electricity generated in fuel cell stack 3. Collecting plate 2 may be placed between fuel cell stack 3 and end plate 1. Collecting plate 4 may be placed between fuel cell stack 3 and end plate 5.

Cell stack 3, end plates 1 and 5 and collecting plates 2 and 4 may be joined together by one or more connecting members 6 that run through bolt holes (not shown in FIG. 1) extending through the contacting surfaces of the unit fuel cells within the fuel cell stack 3, the collecting plates 2 and 4, and the end plates 1 and 5. The connecting members may be bolts having a broad head and a threaded end as shown in FIG. 1, or the connecting members may have both ends threaded (not shown in FIG. 1). A nut 7 may be engaged to each threaded end of a connecting member 6, and tightened to a predetermined load or torque to apply a surface pressure to the contact surfaces between the unit fuel cells 10 within the fuel cell stack 3, the collecting plates 2 and 4, and the end plates 1 and 5.

FIG. 2 is an enlarged cross-sectional side view of a unit fuel cell including a membrane electrode assembly 20 using an electrode separator assembly according to an embodiment of the present invention. As shown in FIG. 2, each unit fuel cell includes an anode 11, a cathode 12, and an electrolyte membrane 21 disposed between the anode 11 and cathode 12. The electrolyte membrane 21 may be preferably a solid polymer electrolyte membrane. As described below, each unit fuel cell 10 generates electric power as a result of the electrochemical reaction of fuel gas and oxidant gas at or within the membrane electrode assembly 20.

Unit fuel cell 10 has a structure wherein membrane electrode assembly 20 is placed between anode separator 26 and cathode separator 27. Membrane electrode assembly 20 includes electrolyte membrane 21, anode 11 and cathode 12. Electrolyte membrane 21 is located in the center of membrane electrode assembly 20 and separates (i.e. isolates) fuel gas from oxidant gas so that they are not mixed in the bulk working fluid streams supplied to each unit fuel cells 10 within the fuel cell stack (reference numeral 3 in FIG. 1). Electrolyte membrane 21 transports hydrogen ions generated at anode 11 to cathode 12.

Anode 11 includes anode catalyst layer 22 and anode gas diffusion layer 23. Anode catalyst layer 22 catalyzes an electrochemical reaction in which hydrogen contained in the fuel gas is converted to hydrogen ions and electrons. Anode catalyst layer 22 may be formed outside electrolyte membrane 21. Anode gas diffusion layer 23 diffuses the supplied fuel gas to anode catalyst layer 22. Anode gas diffusion layer 23 may be formed outside anode catalysis layer 22.

Cathode 12 includes cathode catalyst layer 24 and cathode gas diffusion layer 25. Cathode catalyst layer 24 catalyzes an electrochemical reaction in which water is generated by reacting hydrogen ions and electrons that are generated in anode 11, with oxygen that is contained in the oxidant gas. The transfer of electrons from anode 11 to cathode 12 creates an electric current that may be used to provide electrical power to an external load (not shown in FIG. 2). Cathode catalyst layer 24 may be formed outside electrolyte membrane 21 and in the opposite side of anode catalyst layer 22. Cathode gas diffusion layer 25 diffuses the supplied oxidant gas to cathode catalyst layer 24. Cathode catalyst layer 25 may be formed outside cathode catalyst layer 24.

Anode separator 26 may be formed in a rectangular-plate shape. Anode separator 26 is placed outside anode gas diffusion layer 23. Surface grooves 26a may be formed in the center of anode separator 26. As shown in FIG. 2, grooves 26a may be formed adjacent the contact surfaces with membrane electrode assembly 20 and create anode gas flow channel 28.

Cathode separator 27 may be formed in a rectangular-plate shape. Cathode separator 27 is placed outside cathode gas diffusion layer 25. As in anode separator 26, surface grooves 27a may be formed in the center of cathode separator 27. Grooves 27a may be formed adjacent the contact surfaces with membrane electrode assembly 20 and create cathode gas flow channel 29. Also, cathode separator 27 creates cooling water flow channel 30 within the electrode separator assembly 40 upon joining the anode separator 26 to the cathode separator 27. Cooling water flow channel 30 may be used to provide cooling water to adjoining unit fuel cells 10 by using the internal surfaces of the grooves 26a of anode separator 26 and the grooves 27a of cathode separator 27 to form a flow conduit.

Furthermore, to collect electricity generated by the electrode reaction, anode separator 26 and cathode separator 27 are preferably made of a material that exhibits good electrical conductivity. According to an exemplary embodiment, anode separator 26 and cathode separator 27 are made of metal. Moreover, when anode separator 26 is joined with cathode separator 27, they constitute electrode separator assembly 40. According to another exemplary embodiment, anode separator 26 is joined with cathode separator 27 by welding.

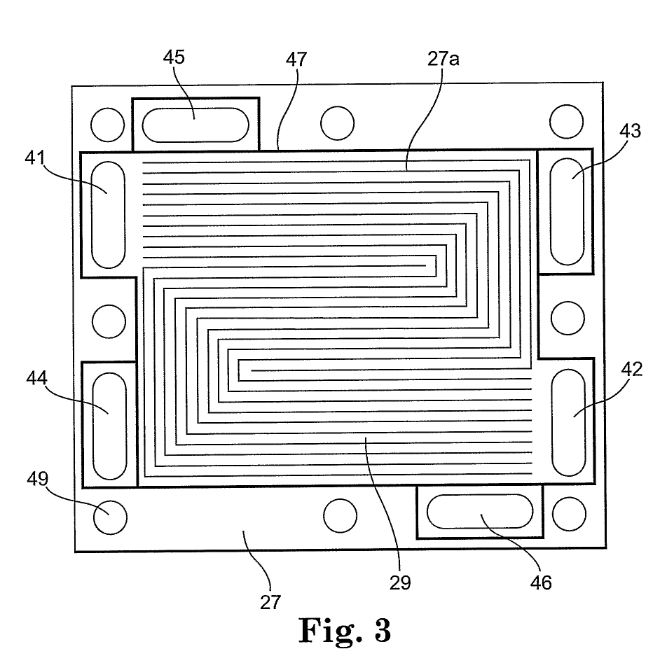

FIG. 3 is a side perspective view illustrating the contact surface of the cathode separator 27 with the cathode surface of the membrane electrode assembly 20 of a unit fuel cell according to an embodiment of the present invention. oxidant gas entrance manifold 41, oxidant gas exit manifold 42, hydrogen entrance manifold 43, fuel gas exit manifold 44, cooling water entrance manifold 45 and cooling water exit manifold 46 are placed in the edges of cathode separator 27.

As described above, cathode separator 27 may be formed in a generally rectangular shape defined by the perimeter of the fuel cell assembly 3. In addition, each of the cathode separator 27, cathode 12, solid polymer electrolyte membrane 21, anode 11, and anode separator 26 for each unit fuel cell 10 may include edges surrounding the contact surfaces between these fuel cell elements, and the edges may form a generally rectangular peripheral edge perimeter for each unit fuel cell.

Cathode separator 27 is illustrated with grooves 27a formed in the contact surface of the cathode separator 27 that create cathode gas flow channel 29 in the contact surface with electrolyte membrane 21. The cathode gas flow channel 29 may define a generally serpentine path as shown in FIG. 3, but other paths are within the scope of the invention.

Upon joining the anode separator 26 to the cathode separator 27 to form an electrode separator assembly 40, the interior contact surfaces of the grooves 27a may create a fluid conduit 30. The fluid conduit 30 may be used to transport a fuel cell working fluid, for example, a fuel gas, an oxidant gas, or cooling water, to each unit fuel cell 10 in the fuel cell stack 3. In FIG. 3, grooves 27a are shown formed in a serpentine pattern in the center of cathode separator 27 for purpose of illustration.

As shown in FIG. 3, the cathode separator may have continuous grooves that create fuel cell working fluid manifolds, for example, fuel gas manifolds, oxidant gas manifolds and/or cooling water manifolds, in the area surrounding the activating surface defined by the electrochemically active surface region for the anodes, cathodes or membranes. Generally, the activating surfaces correspond to the region where the serpentine grooves 27a may be formed on the surface of the cathode separator 27. oxidant gas entrance manifold 41 and oxidant gas exit manifold 42 may be formed on a diagonal pair of the fuel cell edges of cathode separator 27. oxidant gas entrance manifold 41 and oxidant gas exit manifold 42 are placed on the diagonal line of cathode separator 27. oxidant gas entrance manifold 41 and oxidant gas exit manifold 42 are connected through cathode gas flow channel 29 in the contact surface with membrane electrode assembly 20 of cathode separator 27.

Cathode gas flow channel 29 may be sealed from hydrogen entrance manifold 43, fuel gas exit manifold 44, cooling water entrance manifold 45, cooling water exit manifold 46 and the outside by welding line 47 which joins the adjacent separators. Welding line 47 is shown in a thick line in FIG. 3. Furthermore, hydrogen entrance manifold 43 may be placed in the same fuel cell edge as oxidant gas exit manifold 42 and fuel gas exit manifold 44 may be placed in the same fuel cell edge as oxidant gas entrance manifold 41.

Cooling water entrance manifold 45 and cooling water exit manifold 46 may be formed in a diagonal pair of the long sides. In the opposite side of the surface shown in FIG. 3, cooling water entrance manifold 45 and cooling water exit manifold 46 are connected with cooling water flow channel 30 that may be formed by the above described grooves 26a of anode separator 26 and grooves 27a of cathode separator 27. Moreover, bolt holes 49 which penetrate the unit fuel cells 10, membrane electrode assemblies 20, and electrode separator assemblies 40, may be used in combination with conjunction bolts which tighten laminated unit fuel cells 10, may be placed proximate the outer perimeter of cathode separator 27. In certain embodiments, bolt holes 49 may be positioned proximate each manual, for example, between each manifold.

Anode separator 26 includes oxidant gas entrance manifold 41, oxidant gas exit manifold 42, hydrogen entrance manifold 43, fuel gas exit manifold 44, cooling water entrance manifold 45 and cooling water exit manifold 46. Hydrogen entrance manifold 43 and fuel gas exit manifold 44 are connected through anode gas flow channel 28 in the contact surface with membrane electrode assembly 20 of anode separator 26.

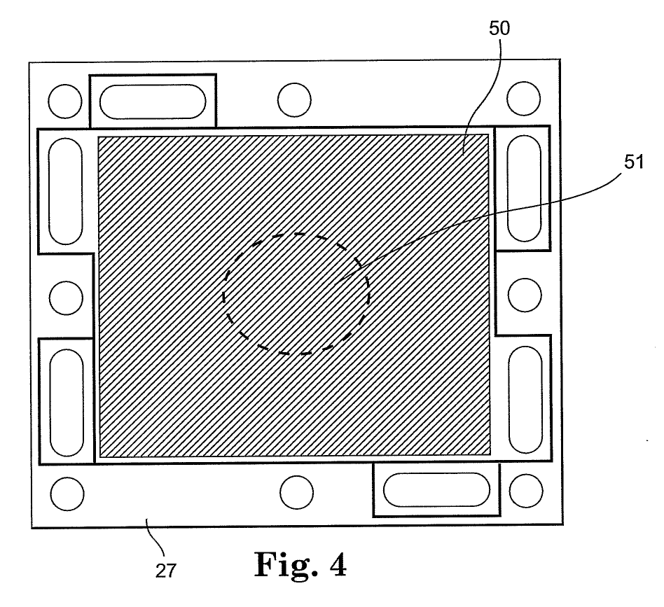

FIG. 4 is a side perspective view illustrating the active surface and contact surface of the cathode separator 27 with membrane electrode assembly 20 showing the contact area joining the cathode separator 27 and anode separator 26 according to an embodiment of the present invention. The diagonally hatched area in the figure shows electrode contact surface 50 where cathode separator 27 is contacted with membrane electrode assembly 20. Electrode contact surface 50 is almost the same as the area where grooves 27a may be formed. According to the present embodiment, the vicinity of the center of electrode contact surface 50 may be welded area 51 as shown in FIG. 4.

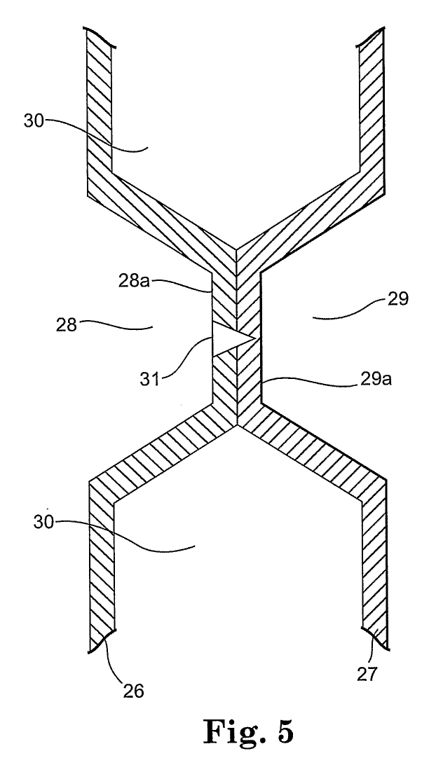

FIG. 5 is an enlarged cross-sectional side view of a portion of the electrode separator assembly 40 illustrating a joint formed between a contact surface of the anode separator 26 and the adjoining cathode separator 27 of a unit fuel cell according to an embodiment of the present invention.

Electrode separator assembly 40 may be welded at bottom surface 28a of anode gas flow channel 28 and bottom surface 29a of cathode gas flow channel 29. An exemplary welding point 31 is shown, but the welds may be formed at any location where the surface of the anode separator 26 contacts a surface of the cathode separator 27. Exemplary welding methods include laser welding and electron beam welding. To prevent deformation of the metal separator during the welding process, welding is preferably carried out from the center to the outer perimeter of the electrode separator assembly 40.

Furthermore, it may be preferred that the perimeter of electrode contact surface 50 (illustrated in FIG. 4 as bold lines defining the generally rectangular perimeter around the hatched region of the electrode contact surface 50) and the regions surrounding the manifolds for the fuel cell working fluids (also shown in FIG. 4 as bold lines) be joined (e.g. by welding) for containing fuel cell working fluids such as fuel gas, oxidant gas, and cooling water.

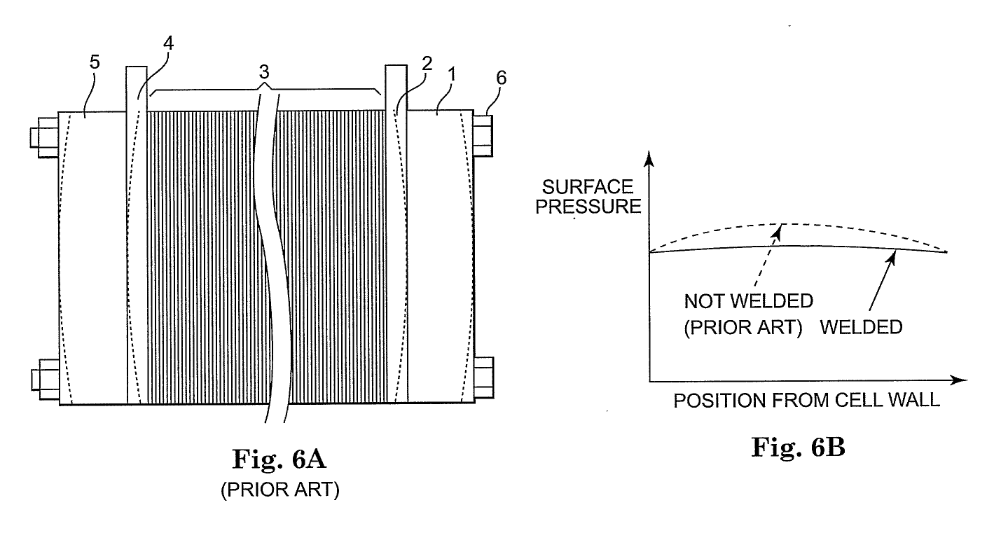

FIG. 6A is a side perspective view illustrating bowing of end plates and collecting plates of an un-welded fuel cell assembly. The dotted line shown in FIG. 6(A) indicates the bowing of the end plates when the separators are not welded in a Prior Art fuel cell stack.

FIG. 6B is a graph illustrating the relationship between the surface pressure and bowing of the end plates and collecting plates of an un-welded Prior Art fuel cell assembly and a welded fuel cell assembly according to another embodiment of the present invention. In FIG. 6(B), the horizontal axis shows the size of the surface pressure and the surface pressure increases towards the left side. Also, the vertical axis shows the position and corresponds to the position of the fuel cell shown in FIG. 6(A). Here, the dotted line indicates the case where the separators are not welded and the continuous line indicates the case of the present invention where the separators are welded.

As shown in FIGS. 6A and 6B, when a fuel cell stack may be formed by stacking and bolting together unit fuel cells 10, the surface pressure proximate the center of the separators may be decreased because the center of the end plates may be bowed towards the opposite side of fuel cell stack 3 in a convex shape. On the other hand, by welding anode separator 26 and cathode separator 27 in the welded area 51, it may be possible to prevent decrease of the surface pressure in the center of the separators.

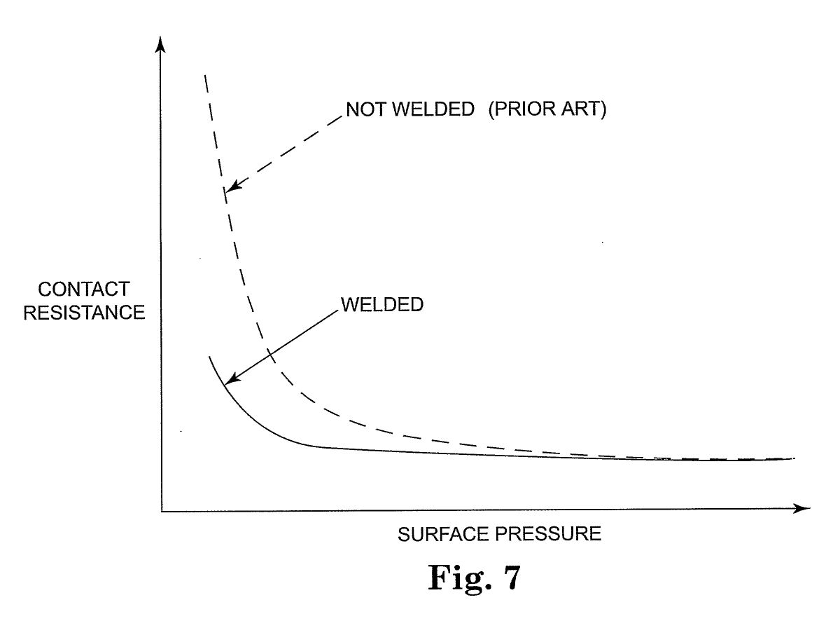

FIG. 7 is a graph illustrating the relationship between the surface pressure and the contact resistance of an un-welded Prior Art fuel cell assembly and a welded fuel cell assembly according to another embodiment of the present invention. In FIG. 7, the horizontal axis indicates the surface pressure of the unit fuel cell, and the vertical axis represents the resulting contact resistance. The dotted line in FIG. 7 indicates the case of the Prior Art unit fuel cell electrode separator assemblies that are not welded, and the continuous line indicates the case where the separators are welded along welded area 51 as shown in FIG. 4. Here, the contact resistance means the electric resistance that is generated in the contact surface when electric current runs through two conductors that are contacted with each other.

As shown in FIG. 7, by welding anode separator 26 with cathode separator 27 in welded area 51, it may be possible to decrease the contact resistance without creating a large load on the end plates. According to the present embodiment, since the vicinities of the centers of the areas that are respectively covered with the electrodes of anode separator 26 and cathode separator 27 are welded, it may be possible to prevent the bowing of the centers that may be caused by the bending of the end plates during the application of the load after the lamination. Therefore, by preventing a decrease of the surface pressure of the centers of the separators and decreasing the contact resistance, it may be possible to prevent a decrease of the power generation property.

Furthermore, according to an embodiment of the present invention, since the rigidity between the separators may be increased due to joining (e.g. by welding) of the center parts of the separators, it may be possible to reduce deformation such as bending and twisting of the fuel cell stack after formation by stacking unit fuel cells. Moreover, since cooling water flow channel 30 which connects anode separator 26 with cathode separator 27 may be sealed by welding, the rigidity of the separators may be further improved, as may be their resistance to deformation.

Also, according to the present invention, it may not be necessary to increase the rigidity of the end plates to make the surface pressure uniform. Therefore, it may be possible to make a smaller and lighter stack at lower cost.

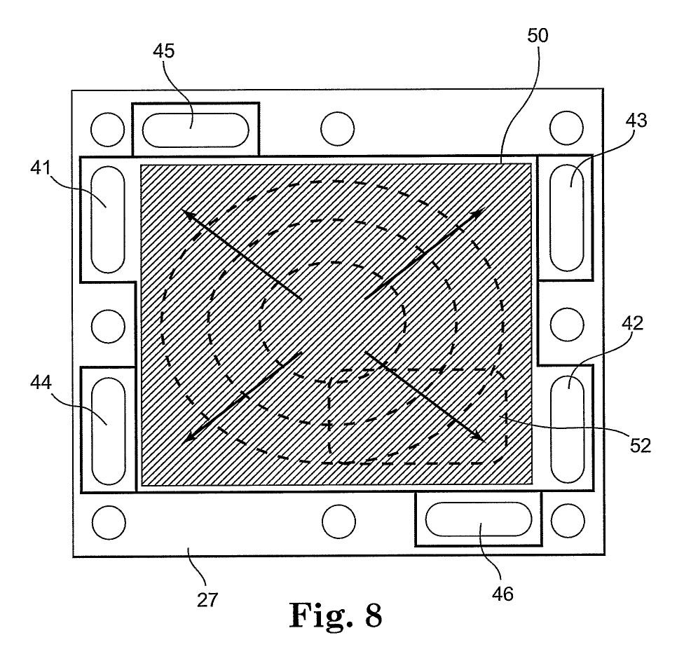

FIG. 8 is a side perspective view illustrating the joints (e.g. welds) formed between the contact surfaces of the cathode separator and the cathode of the membrane electrode assembly of a unit fuel cell in a fuel cell stack according to another embodiment of an electrode separator assembly of the present invention. FIG. 8 illustrates the distribution of the weld density of the whole area of electrode contact area 50 of cathode separator 27 of Embodiment 2 of the electrode separator assembly of the present invention. Here, the weld density means the area of the welded part per unit area. Here, in each embodiment described below, the same codes are assigned to the parts that have the same functions as those of the above described embodiment thereby omitting the overlapped explanation.

As shown in FIG. 8, the weld density may be decreased in the direction of the arrow from the center of electrode contact area 50 to its outer perimeter. As is the case with the previously described embodiments, in the present embodiment, the welding may be done from the center to the outer perimeter to decrease the deformation by the welding. Also, the weld density may be decreased in area 52 proximate oxidant gas exit manifold 42 compared with other areas. Similarly in anode separator 26, the weld density may be decreased proximate fuel gas exit manifold 44.

Air that is introduced through oxidant gas entrance manifold 41 and discharged from oxidant gas exit manifold 42 may contain moisture generated by the electrochemical reaction in electrolyte membrane 21. Also, partially reacted fuel gas leaving exit manifold 44 may contain moisture that is swept from the surface of electrolyte membrane 21 and discharged. Therefore, the material around oxidant gas exit manifold 42 and fuel gas exit manifold 44 may be easily corroded by moisture carried in the oxidant and fuel gases.

According to another embodiment, as shown in FIG. 6, as the surface pressure is increased from the center of electrode contact area 50 to its outer perimeter, the weld density of the separators may be decreased. As a result, the contact resistance of the area where the surface pressure is low may be decreased and at the same time the contact resistance within the surface can be made uniformed. Also, since the rigidity of the separators may be increased by welding anode separator 26 to the cathode separator 27, welding the anode 11 to the anode separator 26, and the cathode 12 to the cathode separator 27, it may be possible to reduce deformation of the fuel cell assembly resulting from bending and twisting of the fuel cell stack 3. This may also prevent leakage of working fluids from the fuel cell assembly, particularly for fuel cells subjected to vibration and external forces resulting from sudden acceleration or deceleration. In addition, the electrical contact between unit fuel cells 10 within the fuel cell stack 3 may be more uniformly maintained, thereby reducing the risk of short circuits.

Furthermore, according to the present embodiment, the weld density may be decreased in the vicinities of oxidant gas exit manifold 42 and fuel gas exit manifold 44. As a result, by containing the corrosion that may be generated from the welding line in the vicinities of oxidant gas exit manifold 42 and fuel gas exit manifold 44 that are easily corroded, it may be possible to improve the durability and life of the fuel cell stack 3 and the fuel cell assembly.

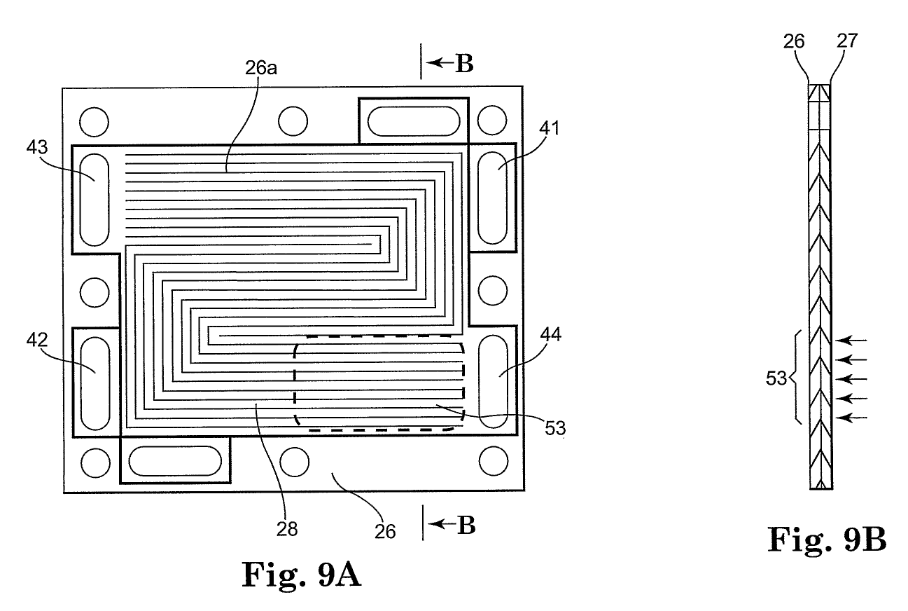

FIG. 9A is a side perspective view illustrating the position of the joints (e.g. welds) to be formed on the contact surface of the anode separator 26 with the anode 11 of the membrane electrode assembly 20 of a unit fuel cell 10 in a fuel cell stack 3 according to another embodiment of an electrode separator assembly 40 of the present invention.

FIG. 9B is an edge cross-sectional view illustrating the electrode separator assembly 40 formed by joining one or more of the contact surfaces between the anode separator 26 and the adjoining cathode separator 27 according to the embodiment of an electrode separator assembly 40 of the present invention.

In particular, FIGS. 9A and 9B illustrate the direction in which anode separator 26 may be welded in another embodiment of the invention. FIG. 9A is a view illustrating the surface of anode gas flow channel 28 and FIG. 9B is a cross-sectional view of FIG. 9A along the line B-B. Area 53 proximate fuel gas exit manifold 44 of anode separator 26 that is shown in FIG. 9A may be welded on the surface of cathode separator 27 as shown in FIG. 9B. Also, the weld density in area 53 proximate fuel gas exit manifold 44 may be decreased compared with the surrounding area.

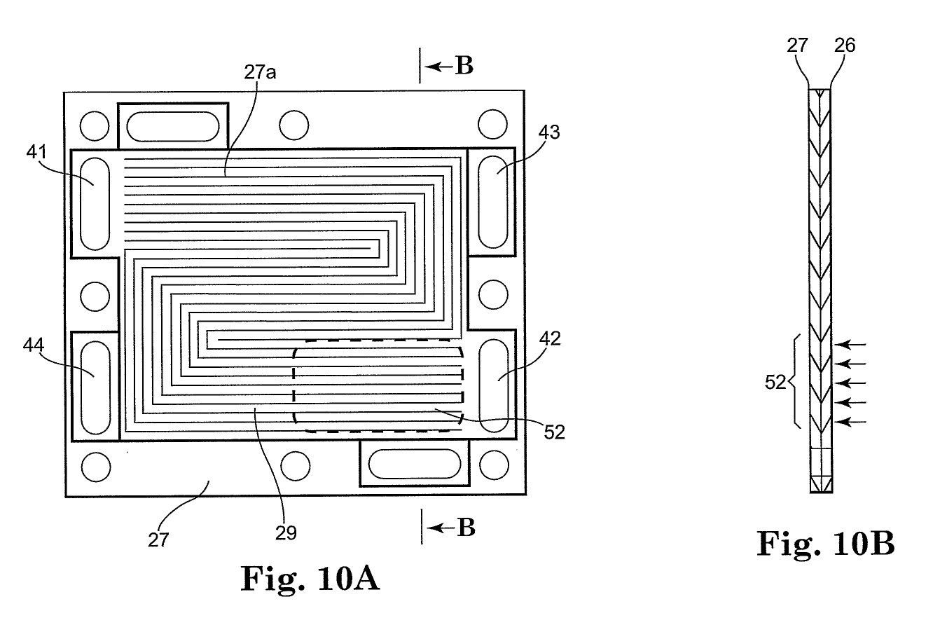

FIG. 10A is a side perspective view illustrating the position of the joints (e.g. welds) to be formed on the contact surface of the cathode separator 27 with the cathode 12 of the membrane electrode assembly 20 of a unit fuel cell 10 in a fuel cell stack 3 corresponding to the embodiment of an electrode separator assembly 40 illustrated in FIGS. 9A and 9B.

FIG. 10B is an edge cross-sectional view illustrating the electrode separator assembly 40 formed by joining one or more of the contact surfaces between the anode separator 26 and the adjoining cathode separator 27 according to the embodiment of an electrode separator assembly 40 illustrated in FIGS. 9A and 9B.

In particular, FIGS. 10 and 10B illustrates the direction in which cathode separator 27 may be welded in the embodiment of an electrode separator assembly 40 illustrated in FIGS. 9A and 9B. FIG. 9A is a view illustrating the surface of cathode gas flow channel 29 and FIG. 9B is a cross-sectional view of FIG. 9A along the line B-B. The structure of the present embodiment is generally the same as that of the first embodiment illustrated in FIGS. 1-5.

Also, as in the case with the second embodiment illustrated by FIGS. 8A and 8B, the distribution of the weld density on electrode contact area 50 between anode separator 26 and cathode separator 27 may decrease in moving from the center to the outer perimeter. Area 52, positioned proximate oxidant gas exit manifold 42 of cathode separator 27 as shown in FIG. 9A, may be welded from anode separator 27 as shown in FIG. 9(B). The weld density in area 52 proximate oxidant gas exit manifold 42 may also decrease as compared to the surrounding area.

According to the present described embodiments, not only the weld density of the area proximate the exit manifold of the fuel cell working fluids may be decreased, but also the welding may be carried out on the opposite surface of the gas flow channel. As a result, by minimizing the contact area of the welded part with moisture in the vicinities of oxidant gas exit manifold 42 and fuel gas exit manifold 44, where metal parts may be readily corroded, it may be possible to improve the durability of the welds and the fuel cell stack assembly.

The present invention is not limited to the previously described embodiments. Thus, it is possible to make a variety of modifications and changes within the scope of the technological disclosure and claims of the present invention, and these modifications and changes are equivalent to the present invention. For example, the position of one or more of the fuel cell working fluid manifolds, and the form, shape or layout of the flow channels for each working fluid shown in FIG. 3 are but one exemplary embodiment, and the present invention is not limited to this embodiment.

As another example, the number, types and positions of unit fuel cells, membrane electrode assemblies, electrode separator assemblies, collecting plates, and end plates in the fuel cell assembly may vary from the illustrated embodiments. Moreover, as for the anode separator and cathode separator, the present invention is not limited to metal separators. For example when carbon separators are used, the separators may be joined using other joining means, such as soldered joints, adhesive joints (e.g. using adhesive bonding agents), and the like.

Furthermore, as for the bolting together members, the present invention is not limited to the particular type or number of connecting members that can be used, and other connecting methods may be used. In addition, bolt holes may be placed proximate the outer perimeter of the separators without particular regard to number or location, but the bolting method and the position of the bolt holes in the illustrated embodiments are only illustrative embodiments, and the present invention is not limited to these particular embodiments.

Various embodiments of the invention have been described. These and other embodiments are within the scope of the following claims.

1. A fuel cell system, comprising:
a plurality of unit fuel cells arranged in a stack of adjoining unit fuel cells, each unit fuel cell comprising a membrane electrode assembly including an anode, a cathode, and a solid polymer electrolyte membrane disposed between the anode and the cathode;
an anode separator positioned between each unit fuel cell in contact with the anode of the membrane electrode assembly of each unit fuel cell within the stack; and
a cathode separator positioned between each unit fuel cell in contact with the cathode for the membrane electrode assembly of each adjoining unit fuel cell within the stack;
wherein a surface of the anode separator for each unit fuel cell is joined to a surface of the cathode separator for each adjoining unit fuel cell to form an electrode separator assembly.

2. The fuel cell system of claim 1, wherein the fuel cell stack is held together by a plurality of connecting members, wherein each connecting member extends through each electrode separator assembly and each membrane electrode assembly without penetrating an activating surface of an anode, a cathode, or a solid polymer electrolyte membrane.

3. The fuel cell system of claim 2, further comprising one or more end plates positioned at an end of the fuel cell stack in contact with one of a cathode separator or anode separator, wherein each connecting member extends through a bolt hole formed through a contact surface between each electrode separator assembly, membrane electrode assembly, and end plate.

4. The fuel cell system of claim 1, wherein each anode separator is joined to each adjoining cathode separator by a plurality of joints formed between one or more of the contact surfaces between the anode separator and the adjoining cathode separator.

5. The fuel cell system of claim 4, wherein each of the cathode separator, cathode, solid polymer electrolyte membrane, anode, and anode separator for each unit fuel cell comprise edges surrounding the contact surfaces, the edges forming a generally rectangular peripheral edge perimeter for each unit fuel cell.

6. The fuel cell system of claim 5, wherein an edge of each unit fuel cell is joined to an edge of the adjoining unit fuel cell and held together by at least one connecting member extending through the fuel cell stack at a position proximate each edge.

7. The fuel cell system of claim 5, wherein the number of joints positioned on a contact surface of each anode separator with the adjoining anode decreases from a position proximate a center of the contact surface with respect to the peripheral edge perimeter, to a position proximate the peripheral edge perimeter of each unit fuel cell.

8. The fuel cell system of claim 7, wherein each anode separator is joined to the adjoining cathode separator by at least one joint positioned proximate the center of the contact surface of each anode separator.

9. The fuel cell system of claim 1, wherein the anode separators and cathode separators comprise a metal, and wherein each anode separator is joined to each cathode separator of the adjoining unit fuel cell by one or more welds.

10. The fuel cell system of claim 9, wherein the unit fuel cells within the fuel cell stack each comprise a plurality of edges defining an outer perimeter for each unit fuel cell, and wherein a weld may be formed between each anode separator and each adjoining cathode separator proximate an edge of each unit fuel cell.

11. The fuel cell system of claim 9, further comprising a plurality of welds between each anode separator and each adjoining cathode separator, wherein the welds are positioned proximate to a contact surface of each anode separator with each adjoining cathode separator.

12. The fuel cell system of claim 9, wherein the welds are positioned proximate a gas flow channel formed between the anode separator and the cathode separator; wherein the gas flow channel defines a region of low gas moisture content and a region of high gas moisture content region; and wherein the weld density is lower in the high gas moisture content region than in the low gas moisture content region.

13. The fuel cell system of claim 12, wherein the high gas moisture content region comprises a first region between a first face of the anode separator and a first face of an adjoining cathode separator; and wherein the low gas moisture content region comprises a second region between a second face of the anode separator on a side opposite to the first face of the anode separator and a second face of the adjoining cathode separator on a side opposite to the first face of the adjoining cathode separator; and wherein the weld density is higher in the second region than in the first region.

14. The fuel cell system of claim 12, wherein the gas flow channel defines a fuel gas exit on a surface of the anode separator, and wherein the weld density is lower proximate the fuel gas exit than in other areas on the surface of the anode separator.

15. The fuel cell system of claim 12, wherein the gas flow channel defines an oxidant gas exit on a surface of the cathode separator, and wherein the weld density is lower proximate the oxidant gas exit than in other areas on the surface of the cathode separator.

16. The fuel cell system of claim 1, wherein each cathode separator comprises a plurality of grooves formed on a surface of the separator in contact with a surface of the adjoining cathode.

17. The fuel cell system of claim 16, wherein the grooves are arranged in a generally serpentine path forming a fluid direction channel on the surface of each cathode separator.

18. The fuel cell system of claim 1, wherein each anode separator is joined to the cathode separator of each adjoining unit fuel cell to form a fluid conduit between each anode separator and each cathode separator of each adjoining unit fuel cell.

19. The fuel cell system of claim 18, wherein each anode separator is joined to the cathode separator of each adjoining unit fuel cell by a plurality of welds.

20. The fuel cell system of claim 18, wherein the fluid conduit contains a fuel cell working fluid.

21. The fuel cell system of claim 20, wherein the fuel cell working fluid is selected from the group consisting of a fuel gas, an oxidant gas, and water.

22. A fuel cell assembly, comprising:
a plurality of unit fuel cells arranged in a fuel cell stack, each unit fuel cell comprising a membrane electrode assembly including an anode, a cathode, and an electrolyte membrane disposed between the anode and the cathode; and
means for joining each cathode to each anode, thereby electrically connecting each cathode to each anode and providing a delivery path for at least one fuel cell working fluid to each cathode and each anode.

23. The fuel cell assembly of claim 22 wherein the fuel cell working fluid is one or more of the group consisting of a fuel gas, an oxidant gas, and water.

24. A method of making a fuel cell assembly, comprising:
forming a fuel cell stack by stacking a plurality of unit fuel cells, each unit fuel cell comprising a membrane electrode assembly including an anode in contact with an anode separator, a cathode in contact with a cathode separator, and a solid polymer electrolyte membrane disposed between the anode and the cathode; and
joining each anode separator to an adjoining cathode separator of the adjoining unit fuel cell.

25. The method of claim 24, wherein joining is achieved by welding a contact surface of each anode separator to a contact surface of the adjoining cathode separator.

26. The method of claim 25, wherein welding is selected from laser beam or electron beam welding.
